(19) United States
(12) Patent Application Publication
(10) Pub. No.: US 2016/0368370 A1
(43) Pub. Date: Dec. 22, 2016

(54) FUEL TANK STRUCTURE

(71) Applicant: TOYOTA JIDOSHA KABUSHIKI KAISHA, Toyota-shi (JP)

(72) Inventor: Shuichi ASO, Toyota-shi (JP)

(73) Assignee: TOYOTA JIDOSHA KABUSHIKI KAISHA, Toyota-shi (JP)

(21) Appl. No.: 15/066,279

(22) Filed: Mar. 10, 2016

(30) Foreign Application Priority Data
Jun. 16, 2015 (JP) 2015-121261

(51) Int. Cl. B60K 15/03; G01F 23/292

(52) U.S. Cl. CPC B60K 15/03006; G01F 23/292; B60K 2015/03217; B60K 2015/03328

(57) ABSTRACT

A fuel tank structure includes: a fuel tank that is installed in an automobile and that accommodates fuel; a bag-shaped member that is fixed to a ceiling portion of an interior of the fuel tank, and that is formed in the shape of a bag and includes a reflecting film that reflects laser light, and whose state of contact with the fuel is maintained due to the bag-shaped member inflating or deflating in accordance with a height of a liquid surface of the fuel accommodated in the fuel tank; and a distance meter that irradiates laser light toward the bag-shaped member from the ceiling portion or a bottom portion of the fuel tank, and detects reflected light that is reflected from the reflecting film, and measures a distance to a contacting portion of the bag-shaped member and the fuel.

### CROSS-REFERENCE TO RELATED APPLICATION

This application claims priority under 35 USC 119 from Japanese Patent Application No. 2015-121261 filed Jun. 16, 2015, the disclosure of which is incorporated by reference herein.

### BACKGROUND

### Technical Field

The present invention relates to a fuel tank structure.

### Related Art

A fuel tank structure, in which an expanding/contracting film that is bag-shaped (a bag-shaped member) that can inflate and contract is provided within a fuel tank, is disclosed in Japanese Patent Application Laid-Open (JP-A) No. H8-170568 as a fuel tank structure that is installed in an automobile. Further, this JP-A No. H8-170568 discloses a technique of suppressing the generation of evaporated fuel from the liquid surface of the fuel by inflating or contracting the expanding/contracting film so as to cover the liquid surface of the fuel.

### SUMMARY

However, in a case in which a fuel meter is disposed within the fuel tank that is disclosed in the above-described document, the float of the fuel meter interferes with the bag-shaped member, and therefore, it is difficult to sense the remaining amount of the fuel well. Further, if the bag-shaped member is made to be small and the fuel meter is disposed within the fuel tank, the surface area over which the fuel is covered by the bag-shaped member is small, and the effect of suppressing the generation of evaporated fuel is reduced.

In view of the above-described circumstances, an object of the present invention is to provide a fuel tank structure that can sense the remaining amount of fuel well, while suppressing generation of evaporated fuel.

A fuel tank structure of a first aspect includes: a fuel tank that is installed in an automobile and that accommodates fuel; a bag-shaped member that is fixed to a ceiling portion of an interior of the fuel tank, and that includes a reflecting film that reflects laser light, a state of contact of the bag-shaped member with the fuel being maintained due to the bag-shaped member inflating or deflating in accordance with a height of a liquid surface of the fuel accommodated in the fuel tank; and a distance meter that irradiates laser light toward the bag-shaped member from the ceiling portion or a bottom portion of the fuel tank, and detects reflected light that is reflected from the reflecting film thereby measuring a distance to a contacting portion of the bag-shaped member and the fuel.

In the fuel tank structure of the first aspect, the bag-shaped member is fixed to the ceiling portion of the fuel tank interior. This bag-shaped member maintains a state of contact with the fuel by inflating or deflating in accordance with the height of the liquid surface of the fuel. Due thereto, the liquid surface of the fuel can be covered by the bag-shaped member, regardless of the height of the liquid surface of the fuel. Namely, generation of evaporated fuel can be suppressed.

The bag-shaped member is structured to include the reflecting film that reflects laser light. Further, the fuel tank structure is provided with the distance meter that irradiates laser light toward the bag-shaped member from the ceiling portion or the bottom portion of the fuel tank, and detects the reflected light that is reflected at the reflecting film. Due thereto, in a case in which laser light is irradiated from the ceiling portion of the fuel tank, when the laser light irradiated from the distance meter reaches the contacting portion of the bag-shaped member and the fuel, the laser light is reflected by the reflecting film that structures the bag-shaped member. Due to the distance meter sensing the reflected light, the distance meter can measure the distance from the ceiling portion of the fuel tank to the liquid surface of the fuel. On the other hand, in a case in which laser light is irradiated from the bottom portion of the fuel tank, when the laser light that is irradiated from the distance meter passes-through the fuel and reaches the contacting portion of the bag-shaped member and the fuel, the laser light is reflected by the reflecting film that structures the bag-shaped member. Due to the distance meter sensing the reflected light, the distance meter can measure the distance from the bottom portion of the fuel tank to the liquid surface of the fuel. By measuring the distance to the contacting portion of the bag-shaped member and the fuel in this way, the remaining amount of the fuel can be sensed well.

In a fuel tank structure of a second aspect, in the first aspect, the bag-shaped member is made to be a three-layer structure in which both surfaces of the reflecting film are sandwiched by resin layers, and one of the resin layers that is positioned at a side onto which laser light is irradiated with respect to the reflecting film is formed of a resin that is transparent.

In the fuel tank structure of the second aspect, the reflecting film can be prevented from contacting fuel or air, due to the both surfaces of the reflecting film being sandwiched by the resin layers. Due thereto, the reflecting film is protected, and the state of the reflecting film can be maintained good. Further, by forming the resin layer, that is at the side onto which the laser light is irradiated, from a resin that is transparent, the laser light can be transmitted all the way to the reflecting film even in a case in which the reflecting film is protected by the resin layer.

In a fuel tank structure of a third aspect, in the first aspect or the second aspect, the distance meter irradiates laser light from the ceiling portion of the fuel tank toward the bottom portion of the fuel tank.

In the fuel tank structure of the third aspect, because the laser light that is irradiated from the distance meter does not pass-through the fuel, a deterioration in the accuracy of the distance meter can be suppressed as compared with a structure in which laser light is irradiated from the bottom portion.

As described above, in accordance with the fuel tank structure of the first aspect, there is the excellent effect that the remaining amount of fuel can be sensed well, while generation of evaporated fuel is suppressed.

In accordance with the fuel tank structure of the second aspect, there is the excellent effect that a deterioration in the sensing accuracy of the distance meter, that is due to deterioration of the bag-shaped member over time, can be suppressed.

In accordance with the fuel tank structure of the third aspect, there is the excellent effect that the accuracy of sensing the remaining amount of fuel can be maintained good.

### BRIEF DESCRIPTION OF THE DRAWINGS

Embodiments of the present invention will be described in detail based on the following figures, wherein:

FIG. 1 is a drawing that schematically shows a fuel tank structure relating to a first embodiment, and is a drawing that shows a state in which fuel is accommodated about halfway in a fuel tank;

FIG. 2 is a drawing that corresponds to FIG. 1 and shows a state in which the height of the liquid surface of the fuel is positioned in a vicinity of the bottom portion of the fuel tank;

FIG. 3 is a cross-sectional view showing the state cut along line 3-3 of FIG. 1;

FIG. 4 is an enlarged sectional view showing, in an enlarged manner, a cross-section of a bag-shaped member that structures the fuel tank structure relating to the first embodiment;

FIG. 5 is a graph showing the relationship between distance that is measured by a laser distance meter and a remaining amount of fuel, relating to the first embodiment;

FIG. 6 is a drawing that schematically shows a fuel tank structure relating to a second embodiment, and is a drawing that shows a state in which fuel is accommodated about halfway in a fuel tank;

FIG. 7 is an enlarged sectional view showing, in an enlarged manner, a cross-section of a bag-shaped member that structures the fuel tank structure relating to the second embodiment; and

FIG. 8 is a graph showing the relationship between distance that is measured by a laser distance meter and a remaining amount of fuel, relating to the second embodiment.

### DETAILED DESCRIPTION

### First Embodiment

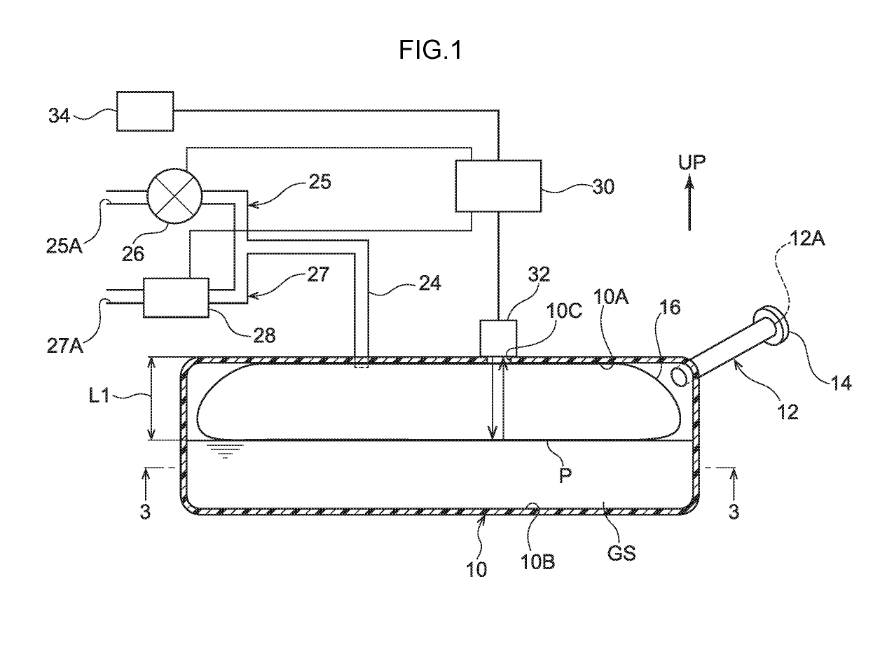

A fuel tank structure relating to a first embodiment is described hereinafter with reference to FIG. 1 through FIG. 5. Note that arrow UP that is shown appropriately in the respective drawings indicates the upper side of a fuel tank. Further, in the present embodiment, the upper side of the fuel tank and the upper side in the vehicle vertical direction coincide with one another.

As shown in FIG. 1, a fuel tank 10, that structures the fuel tank structure relating to the present embodiment, is formed in a hollow shape, and is formed in a shape (e.g., the shape of a substantially parallelepiped box) that can accommodate liquid fuel (hereinafter called “fuel GS”) in the interior thereof. Further, the lower surface of the fuel tank 10 is supported by an unillustrated tank band. The fuel tank 10 is mounted to an unillustrated floor panel due to this tank band being fixed to the floor panel via brackets or the like.

A filler pipe 12 that is substantially tubular is connected to the fuel tank 10. A refueling port 12A is formed in the upper end portion of the filler pipe 12. Refueling is carried out due to a refueling gun being inserted into this refueling port 12A and the fuel GS being filled into the fuel tank 10. Note that, in a case in which there is a large amount of the fuel GS within the fuel tank 10, some of the fuel GS is accommodated in the filler pipe 12 as well.

The refueling port 12A at the upper end of the filler pipe 12 is opened and closed by a fuel cap 14. An unillustrated fuel lid, that is provided at a side panel or the like of the vehicle body, is disposed at the outer side of the fuel cap 14.

In the closed state, the fuel cap 14 closes-off the refueling port 12A, and limits access of a refueling gun to the filler pipe 12. In contrast, when the fuel cap 14 is opened, the refueling port 12A of the filler pipe 12 is opened, and access of a refueling gun to the refueling path is possible.

Further, an unillustrated fuel pump is disposed within the fuel tank 10. The fuel GS that is accommodated in the fuel tank 10 is supplied to an engine by this fuel pump.

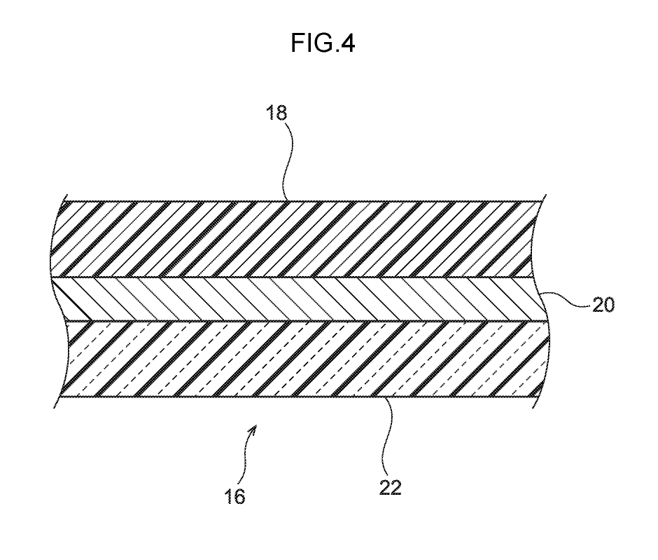

Here, a bag-shaped member 16 is fixed to a ceiling portion 10A of the fuel tank 10 interior. The bag-shaped member 16 is formed in the shape of a bag that can inflate and deflate and whose upper portion is open. Due to the upper end portion of the bag-shaped member 16 being fixed to the ceiling portion 10A, the opening is blocked by the ceiling portion 10A. Further, as shown in FIG. 4, the bag-shaped member 16 is made to be a three-layer structure that includes a metal film 20 that serves as a reflecting film, and a resin layer 18 and a resin layer 22 that are provided at the both surfaces of the metal film 20 so as to sandwich the metal film 20. Note that the upper side in the drawing of FIG. 4 is the inner surface side of the bag-shaped member 16, and the lower side in the drawing is the outer surface side of the bag-shaped member 16. Further, “can inflate and deflate” here is not limited to a structure in which the bag-shaped member 16 itself expands and contracts, and includes members that are bag-shaped and whose volumes are variable such that they deflate by being folded-up and inflate by being unfolded.

The metal film 20 that structures the bag-shaped member 16 is formed of a metal such as aluminum or an aluminum alloy or the like that reflects laser light. Further, the resin layer 18 and the resin layer 22 are formed of thermoplastic resins, and the resin layer 18 is layered on the inner surface side of the metal film 20. Moreover, the resin layer 18 is formed from a resin that is transparent. On the other hand, the resin layer 22 is layered on the outer surface side of the metal film 20, and is formed from a resin that is opaque. Note that “transparent” here is not limited to a structure that transmits all types of light, including visible light, therethrough, and includes the concept of transmitting at least some types of light.

As shown in FIG. 1, an introducing pipe 24 for introducing air into the bag-shaped member 16 is connected to the ceiling portion 10A of the fuel tank 10. Further, one end portion of the introducing pipe 24 is disposed within the fuel tank 10, and communicates with the internal space of the bag-shaped member 16.

The other end portion of the introducing pipe 24 branches-off into a pipe 25 for opening to the atmosphere and an air supply pipe 27. A pressure regulating valve 26 is connected to the pipe 25 for opening to the atmosphere. An opening 25A that opens to the atmosphere is formed at the end portion of the pipe 25 for opening to the atmosphere.

On the other hand, a compressor 28 is connected to the air supply pipe 27. Further, an opening 27A that opens to the atmosphere is formed at the end portion of the air supply pipe 27. Moreover, the pressure regulating valve 26 and the compressor 28 are electrically connected to an ECU (Electronic Control Unit) 30 that is a control section.

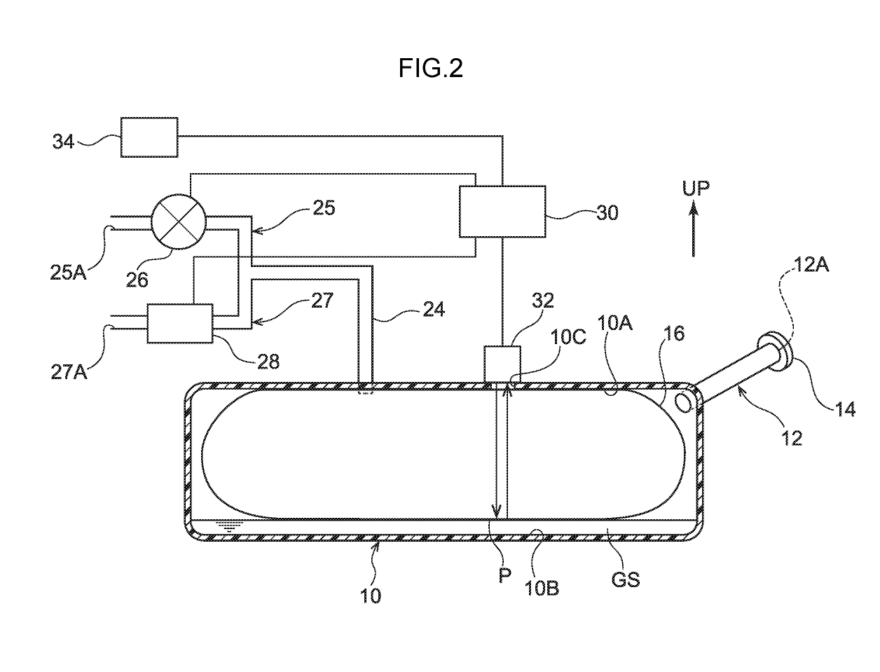

Here, due to the ECU 30 controlling the pressure regulating valve 26 and the compressor 28, the bag-shaped member 16 is inflated or deflated in accordance with the height of the liquid surface of the fuel GS that is accommodated in the fuel tank 10. Namely, due to the ECU 30 controlling the pressure regulating valve 26 and the compressor 28, the state of contact of the bag-shaped member 16 and the fuel GS is maintained. Concretely, as shown in FIG. 2, in a case in which the amount of the fuel GS decreases and the height of the liquid surface falls, the pressure regulating valve 26 is closed by a signal from the ECU 30. Further, the compressor 28 is operated, and compressed air is introduced into the bag-shaped member 16 via the air supply pipe 27 and the introducing pipe 24. Due thereto, the bag-shaped member 16 inflates, and the state of contact of the bag-shaped member 16 and the liquid surface of the fuel GS is maintained.

On the other hand, in a case in which the liquid surface rises due to the amount of the fuel GS increasing due to refueling or the like, the pressure regulating valve 26 is opened by a signal from the ECU 30. Further, in a case in which the compressor 28 is operating, the compressor 28 is stopped by a signal from the ECU 30. Due thereto, the pressure of the internal space of the bag-shaped member 16 falls to atmospheric pressure. Therefore, as the liquid surface of the fuel GS rises, the air at the interior of the bag-shaped body 16 is pushed-out into the introducing pipe 24 and is discharged-out from the opening 25A. In this way, the state of contact of the bag-shaped member 16 and the liquid surface of the fuel GS is maintained.

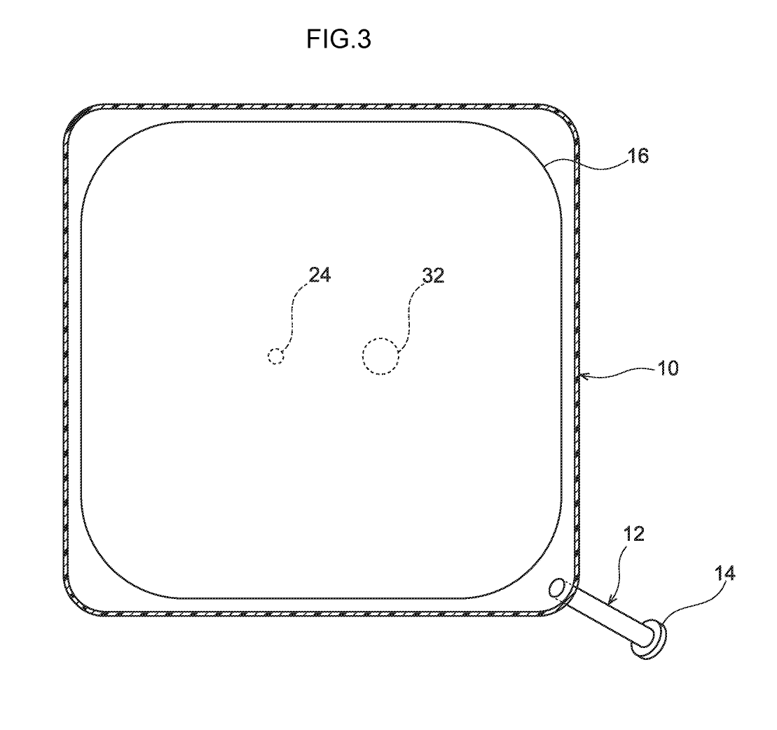

Here, the ECU 30 is electrically connected to a distance meter 32 and a display portion 34. The distance meter 32 is disposed at the upper portion of the fuel tank 10, and is formed in a substantially cylindrical shape. Further, as shown in FIG. 3, the distance meter 32 is disposed at the central portion of the fuel tank 10, as seen from a bottom portion 10B side.

Moreover, as shown in FIG. 1, an illuminating section, that is not shown and that irradiates laser light, and a light-receiving section, that is not shown and that receives reflected light, are provided at the distance meter 32. Further, a through-hole 10C is formed in the ceiling portion 10A of the fuel tank 10, and the laser light can be irradiated from this through-hole 10C toward the bottom portion 10B of the fuel tank 10. Note that, because the through-hole 10C communicates with the internal space of the bag-shaped member 16, the laser light is irradiated from the distance meter 32 toward the interior of the bag-shaped member 16. Further, the region between the distance meter 32 and the fuel tank 10 is sealed, and the air at the interior of the bag-shaped member 16 is prevented from leaking from the through-hole 10C.

The laser light that is irradiated from the distance meter 32 advances directly to contacting portion P of the bag-shaped member 16 and the fuel GS, and is reflected by the metal film 20 that structures the bag-shaped member 16. Further, the reflected light that is reflected at the metal film 20 is detected by the distance meter 32. Then, the distance meter 32 measures distance L1 from the distance meter 32 to the reflecting portion (the contacting portion P of the bag-shaped member 16 and the fuel GS) by determining the difference between the wavelength of the reflected light and a reference wavelength.

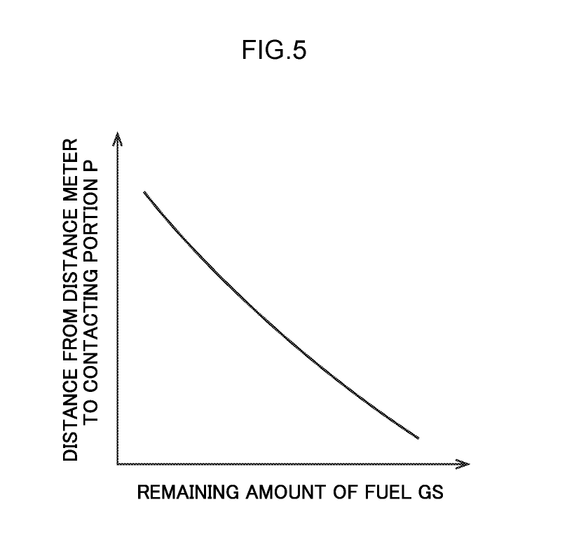

The distance L1 that is measured by the distance meter 32 is transmitted to the ECU 30. Here, the relational expression of the remaining amount of the fuel GS and the distance that is measured by the distance meter 32 (the distance from the distance meter 32 to the contacting portion P) is as per the graph shown in FIG. 5. As shown by this graph, the shorter the distance from the distance meter 32 to the contacting portion P, the greater the remaining amount of the fuel GS, and, the longer the distance from the distance meter 32 to the contacting portion P, the smaller the remaining amount of the fuel GS. On the basis of this relational expression shown in FIG. 5, the ECU 30 computes the remaining amount of the fuel GS, and displays the remaining amount of the fuel GS on the display portion 34 that is a fuel meter or the like that can be seen by a vehicle occupant.

### (Operation and Effects)

Operation and effects of the fuel tank structure relating to the present embodiment are described next.

The present embodiment uses the distance meter 32 that irradiates laser light and detects the reflected light thereof and measures the distance, and is structured so as to detect the remaining amount of the fuel GS from this distance that has been measured by the distance meter 32. Therefore, there is no need to place a fuel meter such as a float or the like within the fuel tank 10. Due thereto, the entire liquid surface of the fuel GS can be covered by the bag-shaped member 16, without a fuel meter and the bag-shaped member 16 interfering with one another. Namely, the remaining amount of the fuel GS can be detected well, while generation of evaporated fuel is suppressed.

Further, in the present embodiment, as shown in FIG. 4, the metal film 20 can be protected by the structure in which the both surfaces of the metal film 20 are sandwiched by the resin layer 18 and the resin layer 22. Namely, oxidization and corrosion of the metal film 20, due to metal film 20 contacting the fuel GS or the moisture or the air or the like that is within the fuel tank 10, is suppressed, and the state of the metal film 20 can be maintained good. Further, by forming the resin layer 18, that is at the side onto which the laser light is irradiated, to be transparent, the laser light can be transmitted all the way to the metal film 20. As a result, the reflected light can be detected well by the distance meter 32, and the accuracy of sensing the remaining amount of the fuel GS can be maintained good. Moreover, by providing the metal film 20, it is difficult for evaporated fuel to pass-through the bag-shaped member 16, as compared with a case in which the bag-shaped member 16 is formed only by the resin layer 18 or the resin layer 22. Namely, discharging of evaporated fuel into the atmosphere can be suppressed.

Further, because the present embodiment is structured such that laser light is irradiated from the ceiling portion 10A of the fuel tank 10 toward the bottom portion 10B, the laser light does not pass-through the fuel GS. In particular, in the present embodiment, because laser light is irradiated onto the inner side of the bag-shaped member 16, the laser light does not hit evaporated fuel. Due thereto, a deterioration in the accuracy of the distance meter 32 can be suppressed as compared with a structure in which laser light passes-through the fuel GS.

Moreover, in the present embodiment, as shown in FIG. 3, the distance meter 32 is disposed at the central portion of the fuel tank 10. Due thereto, as compared with a structure in which the distance meter 32 is disposed in the vicinity of a side wall of the fuel tank 10, the height of the liquid surface of the fuel GS at the position of measurement does not fluctuate greatly, even in a state in which the fuel tank 10 is tilted. As a result, the detection accuracy of the distance meter 32 can be ensured even in a state in which the fuel tank 10 is tilted.

### Second Embodiment

A fuel tank structure relating to a second embodiment is described next with reference to FIGS.

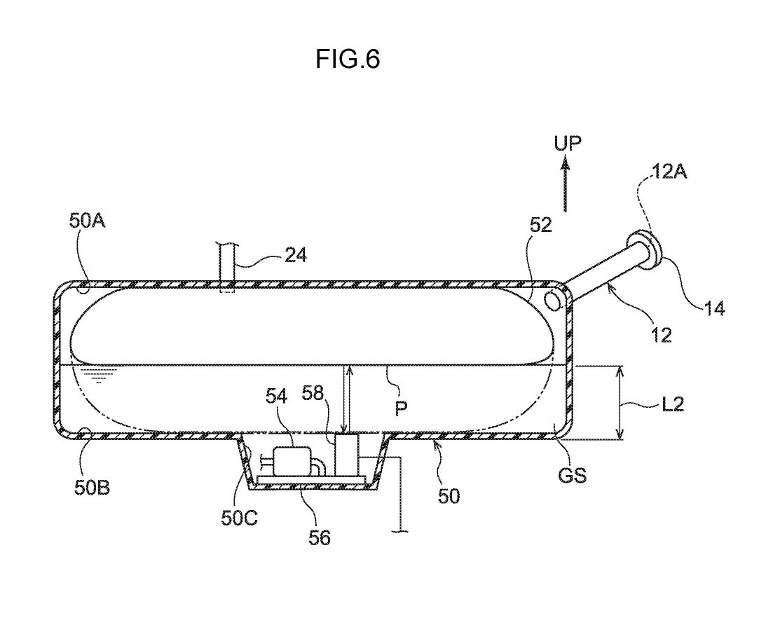

6 through 8. Note that structures that are similar to those of the first embodiment are denoted by the same reference numerals, and description thereof is omitted as appropriate. Further, in FIG. 6, because the structures before the introducing pipe 24 are similar to those of FIG. 1, illustration thereof is omitted.

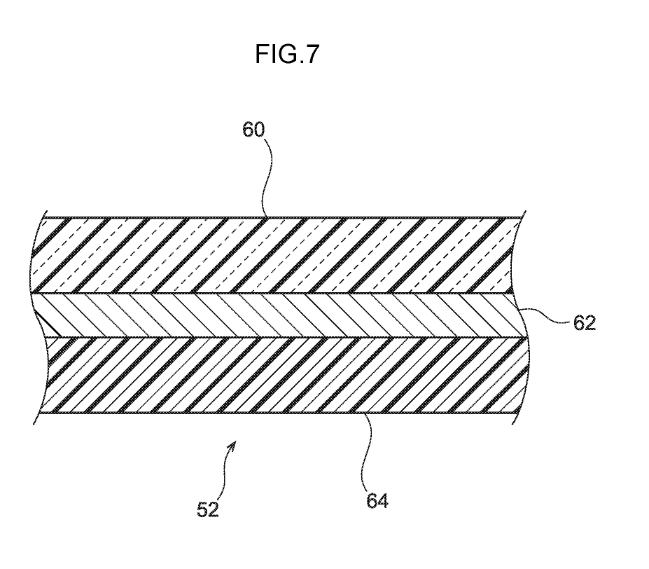

As shown in FIG. 6, a bag-shaped member 52 is fixed to a ceiling portion 50A of a fuel tank 50. Here, as shown in FIG. 7, the bag-shaped member 52 is a three-layer structure that includes a metal film 62 that serves as a reflecting film, and a resin layer 60 and a resin layer 64 that are provided at the both surfaces of the metal film 62 so as to sandwich the metal film 62. Note that the upper side in the drawing of FIG. 7 is the inner surface side of the bag-shaped member 52, and the lower side in the drawing is the outer surface side of the bag-shaped member 52.

The metal film 62 that structures the bag-shaped member 52 is formed of a metal such as aluminum or an aluminum alloy or the like that reflects laser light. Further, the resin layer 60 and the resin layer 64 are formed of thermoplastic resins, and the resin layer 60 is layered on the inner surface side of the metal film 62. Moreover, the resin layer 60 is formed from a resin that is non-transparent. On the other hand, the resin layer 64 is layered on the outer surface side of the metal film 62, and is formed from a resin that is transparent. Namely, in the present embodiment, the resin layer 64 that is transparent is provided at the outer surface side onto which laser light is irradiated with respect to the metal film 62.

As shown in FIG. 6, a concave portion 50C is formed in the central portion of a bottom portion 50B of the fuel tank 50. A fuel pump 54, a filter 56 and a distance meter 58 are disposed in this concave portion 50C.

The filter 56 is disposed at the bottom surface of the concave portion 50C, and is structured such that the fuel GS, that has passed-through the filter 56, is introduced into the fuel pump 54. Due thereto, foreign matter within the fuel GS is trapped by the filter 56 before the fuel GS is introduced into the fuel pump 54.

The fuel pump 54 is a pump that supplies the fuel GS, that is accommodated within the fuel tank 50, to the engine. Due to the fuel pump 54 being disposed in the concave portion 50C, the fuel GS can be supplied to the engine even in a case in which the amount of the fuel GS has become low.

The distance meter 58 has an illuminating portion that is not shown and that irradiates laser light. The distance meter 58 irradiates laser light from the bottom portion 50B of the fuel tank 50 toward the ceiling portion 50A. Further, a light-receiving portion, that is not shown and that detects reflected light, is provided at the distance meter 58. The distance meter 58 measures distance L2 from the distance meter 32 to the reflecting portion (the contacting portion P of the bag-shaped member 52 and the fuel GS) by determining the difference between the wavelength of the reflected light and a reference wavelength.

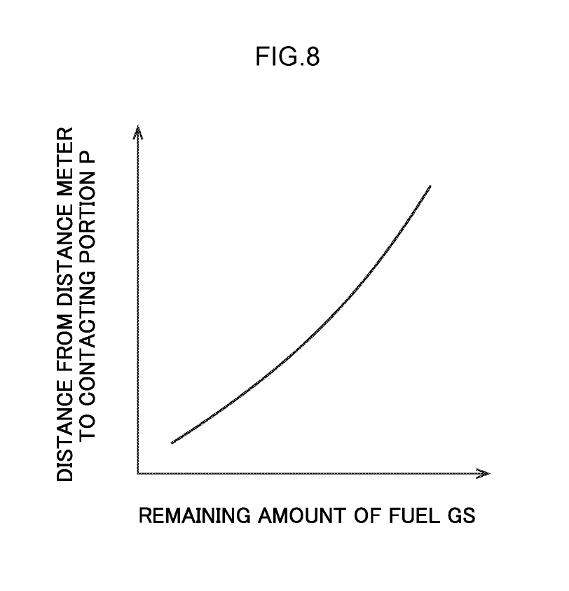

Further, the distance meter 58 is electrically connected to the ECU 30 (see FIG. 1). The ECU 30 computes the remaining amount of the fuel GS on the basis of the results of measurement of the distance meter 58. Concretely, the ECU 30 computes the remaining amount of the fuel GS on the basis of the graph shown in FIG. 8. The graph of FIG. 8 illustrates the relationship between the remaining amount of the fuel GS and the distance measured by the distance meter 58 (the distance from the distance meter 58 to the contacting portion P). Further, as shown by this graph, the shorter the distance from the distance meter 58 to the contacting portion P, the smaller the remaining amount of the fuel GS, and, the longer the distance from the distance meter 58 to the contacting portion P, the greater the remaining amount of the fuel GS. On the basis of this relational expression of the graph shown in FIG. 8, the ECU 30 computes the remaining amount of the fuel GS, and displays the remaining amount of the fuel GS on the display portion 34 that is a fuel meter or the like that can be seen by a vehicle occupant (see FIG. 1).

### (Operation and Effects)

Operation and effects of the fuel tank structure relating to the present embodiment are described next.

In the present embodiment, because the distance meter 58 is disposed at the interior of the fuel tank 50, there is no need to ensure space for placement of the distance meter at the outer side of the fuel tank 50, as compared with the first embodiment.

Further, because the distance meter 58 and the fuel pump 54 are disposed in the concave portion 50C, the distance meter 58 and the fuel pump 54 interfering with the bag-shaped member 52 can be suppressed, even in a state in which the bag-shaped member 52 inflates and contacts the bottom portion 50B of the fuel tank 50. Other operations are similar to those of the first embodiment.

Although a first embodiment and a second embodiment of the present invention have been described above, the present invention is not limited to the above-described structures and can, of course, be implemented in various forms other than the above-described structures within a scope that does not depart from the gist thereof. For example, although the bag-shaped member is a three-layer structure the above-described embodiments, embodiments are not limited to this, and the bag-shaped member may be a two-layer structure in which a metal film is deposited on a resin layer.

Further, although the above-described embodiments employ a metal film as the reflecting film, embodiments are not limited to this. For example, a sheet that is made of resin and is light-reflective, or the like, may be used.

What is claimed is:

1. A fuel tank structure comprising:
a fuel tank that is installed in an automobile and that accommodates fuel;
a bag-shaped member that is fixed to a ceiling portion of an interior of the fuel tank, and that includes a reflecting film that reflects laser light, a state of contact of the bag-shaped member with the fuel being maintained due to the bag-shaped member inflating or deflating in accordance with a height of a liquid surface of the fuel accommodated in the fuel tank; and
a distance meter that irradiates laser light toward the bag-shaped member from the ceiling portion or a bottom portion of the fuel tank, and detects reflected light that is reflected from the reflecting film thereby measuring a distance to a contacting portion of the bag-shaped member and the fuel.

2. The fuel tank structure of claim 1, wherein:
the bag-shaped member is made to be a three-layer structure in which both surfaces of the reflecting film are sandwiched by resin layers, and
one of the resin layers that is positioned at a side onto which laser light is irradiated with respect to the reflecting film is formed of a resin that is transparent.

3. The fuel tank structure of claim 1, wherein the distance meter irradiates laser light from the ceiling portion of the fuel tank toward the bottom portion of the fuel tank.
